(19) United States
(12) Patent Application Publication
(10) Pub. No.: US 2025/0101640 A1
(43) Pub. Date: Mar. 27, 2025

(54) INSPECTION SYSTEM FOR YARN BOBBINS AND METHOD FOR INSPECTING YARN BOBBINS

(71) Applicant: SANKO TEKSTIL ISLETMELERI SANAYI VE TICARET ANONIM SIRKETI BASPINAR SUBESI, Gaziantep (TR)

(72) Inventors: Hakan KONUKOGLU, Gaziantep (TR); Gökhan AYDIN, Gaziantep (TR)

(21) Appl. No.: 18/833,853

(22) PCT Filed: Jan. 28, 2022
(86) PCT No.: PCT/EP2022/052126

§ 371 Date: Jul. 26, 2024

(51) Int. Cl. D01H 13/26; G01N 21/88; G01N 21/952

(52) U.S. Cl. CPC D01H 13/26; G01N 21/952; G01N 2021/8887

(57) ABSTRACT

It is provided an Inspection System for yarn bobbins. It is provided a system with which an automatisation of yarn bobbin inspection can be improved. The system comprising an image acquisition device for acquiring an image of a yarn bobbin, a database in which there is stored a first data set concerning at least a first type of fault, which first data set is generated by using samples of yarn bobbins having the first type of fault, an application for determining whether the yarn bobbin, which is inspected with the image acquisition device has the first type of fault. Further it is provided a method for inspecting yarn bobbins and assign different type of faults thereto.

The present invention is related to an inspection system for yarn bobbins with which yarn bobbins can be inspected to search for faults. Further, it is provided a respective method for inspecting such yarn bobbins.

Until today in the industrial process of yarn production, yarn bobbins are inspected by a human person with their eyes to search for whether there is a specific fault or defect present in the yarn bobbins. If there is such a fault or defect present, the respective bobbin is marked or removed from the bobbins that are to be sent to a customer. There are, however, some techniques disclosed in scientific essays how an inspection can be done by physical measurements, in particular by image inspection systems. Such prior art is described, for example, in the scientific essay Automatic Bobbin Inspection System, J. Baumgartinger, R. König, Lenzinger Berichte, 82 (2003) 70-75 and in the scientific essay An Innovative Solution for Abrage Fault Detection on Yarn Bobbin and Fabric Surface, H. I. Celik, E. Gultekin, L. C. Dulger, H. I. Sunbul, H. Kani in ICENS, 5^{th} International Conference on Engineering and Natural Science, Jun. 12-16, 2019 in Prague.

In the latter essay it is described a general prototype machine vision inspection system using an illumination section and a camera. The illumination section irradiates light having a specific temperature to the surface of the yarn bobbins to make so-called abrage defects (defects which come from abrasion) more visible. These defects are, for example, on the surface of the yarn bobbins and are caused by abrasion. It is shown that by changing the brightness and making adjustments to the image processing of the acquired images that the respective abrage defects (abrasion faults) may be made more visible.

The scientific essay Automatic Bobbin Inspection System (J. Baumgartinger & R. König, 2003) describes the generally known different defects of yarn bobbins, in geometry, macro structural defects and micro structural defects. In particular, it is described how the detection of broken filaments can be executed. A CCD camera records a laser beam reflected on a surface of the yarn bobbin while the yarn bobbin is rotated and is analysed and when the reflected beam fulfils a pre-set condition, it is decided that broken filaments are located on the respective surface. These surfaces are the end surfaces of the bobbin in the longitudinal direction of the bobbin. This system requires a huge effort to set the respective boundary conditions and the like, to detect the broken filaments.

In view of said prior art documents, the present inventors applied a new approach and found that it is possible to use for the determination of whether there is a specific fault present or not at a yarn bobbin, a system working with Artificial Intelligence and/or Deep Learning.

In view of this, it is provided an inspection system having the features defined in claim 1. In the first step, samples of yarn bobbins having a specific type of fault (or defect) are used for acquiring images of the respective yarn bobbins via an image acquisition device. From the acquired images, data is obtained which is saved in the database.

A plurality of yarn bobbins having the respective type of fault is thus used to set up a first dataset in a database. It can then be automatically determined or derived in the later industrial process when further yarn bobbins are assessed as to whether a specific type of fault is present. It can then be decided whether this type of fault is present or not.

Namely, it is decided by the application whether the respective data acquired by the image acquisition device corresponds or substantially corresponds to data in a first dataset. If this is the case it is decided that the first fault is present. In order to have a valid first dataset in the database, it is beneficial in generating said dataset using samples of yarn bobbins having this specific type of fault, which is named “first type of fault”, wherein this first type of fault is respectively provided at different regions or has different aspects. As the variety of aspects of the first type of fault is broad in the respective different samples, the respective first dataset can be better used to identify whether a first fault is contained in the yarn bobbin, which undergoes the inspection during production.

The inspection system may have an image acquisition device for acquiring an image of a yarn bobbin. This image data is compared in the application with a first dataset stored in the database and it is decided by the application whether the yarn bobbin which is inspected with the image acquisition device has a first type of fault or not.

According to a further development, in the database there is stored a second dataset, which corresponds to a second type of fault. This second dataset can also be set up by using samples of yarn bobbins having this second type of fault. The aspects described above for the first data set generation may also apply for the second data set generation.

It is beneficial that the sample yarn bobbins which are used for setting up the respective first and second datasets only have the respective first and/or second faults.

The first and second datasets needs not to be provided in different sections of the database, but can all be saved together within one section of the database. The respective data relating to the first and second dataset may have a respective identifier assigning it to the first or second type of fault. Samples having both types of faults may also be used for setting up the data set. This data may have an identifier corresponding to the first and second type of fault.

With the system it can therefore also be decided whether the fault in a yarn bobbin to be inspected is a second type of fault.

The respective yarn bobbins having these first and/or second type of faults can be removed from a batch of bobbins which are to be shipped to a customer. The respective bobbins having the faults can be sorted to form batches of yarn bobbins having this first type of fault, yarn bobbins having this second type of fault and yarn bobbins having both types of faults.

The respective batches can be placed on different pallets or the like. The respective type of faults can be an elastane-free fault, a damaged bobbin fault, an abrasion fault, a color fault or a diameter fault.

An elastane-free fault should be understood as follows. Some yarns, for example yarns which are used for production of denim, may have a certain elasticity. In order to ensure this elasticity there may be provided at least one elastic filament within the yarn to tune the respective properties. There may be provided further filaments having non-elasticity and these filaments may be twisted together during ring spinning to form a core. This core may be encapsulated by a cover layer comprising, for example, staple fibres being e.g. natural fibres. However, during the spinning (in particular ring-spinning) process it may happen that the elastic filament comprised in the core breaks and therefore there is a region wherein there is no elastic filament provided within the core. This region is called an elastane-free area. Therefore an elastane-free fault is a fault wherein there is an area along the yarn in which there is a region where there is no elastane provided in an elastane containing yarn. This elastane is not delimited to the material correspond to the trademark “Elastane”, but it can be provided by any elastic filament such as Lycra or the like. The present inventors found for the first time that it is possible to detect such elastane-free faults by a specific image acquisition device and with the use of Artificial Intelligence.

A damaged bobbin fault is a fault which relates to any damage to the bobbin itself. The term bobbin, conversely to the term yarn bobbin, is in the present application used only for the shaft in the middle around which the yarn is wound. Therefore, a yarn bobbin comprises a yarn wound around the bobbin. In the following, as long as the term bobbin is used, it is meant the shaft along which the yarn is wound. In the following, when the tern yarn bobbin is used, it is meant the complete arrangement including the yarn wound around the bobbin.

The respective bobbin may be broken or have any other damage. This can, for example, be seen when the image acquisition system is focused on the front end surfaces of the yarn bobbins in the longitudinal direction.

An abrasion fault is a fault which comes from abrasion of the yarn and the bobbin during handling.

A colour fault is a fault in the colour of the yarn. In a specific production process, the yarn may be coloured. The respective outcome should correspond to a standardised colour code. It may be the case that the colour code is depicted, for example via a sticker, on an inside of the bobbin. The respective system may acquire the respective colour code and may decide whether the detected colour of the yarn matches with the colour code or not. With this, it may be ensured that the respective colour that the customer ordered is fulfilled for the respective yarn bobbin.

A diameter fault is a fault in diameter of the yarn bobbin. For a respective batch of bobbins there is usually a predetermined diameter, for example a diameter which the customer ordered. Therefore, in order to manage the respective yarn bobbins to be packaged and shipped to a customer, a diameter fault is determined with the inspection system.

Any of the respective faults can be determined with the same inspection system, alone or in any combination.

That means, that additionally to an elastane-free fault, a damaged bobbin fault and/or an abrasion fault and/or a color fault and/or a diameter fault may be detected.

For the respective faults, different datasets are generated using sample yarn bobbins and this dataset is saved in the database.

From the database, it is decided which of the saved data corresponds to the data of the acquired images and thereby the respective assignment of different faults is done.

The application is configured to determine the type of fault of yarn bobbin which is inspected with the image acquisition device.

The present inventors have further noted that it is beneficial that the application may have a fault assignment module and additionally thereto, a fault marker module. With the fault assignment module, a type of fault in the yarn bobbins which were inspected with the image acquisition device, is assigned to the respective yarn bobbin. With the fault marker module, data is generated for providing a marker which can be overlaid on the image of the yarn bobbin, which is acquired by the image acquisition device.

With such a configuration, a human person (operator) operating the inspection system can better identify a respective fault and where is it located on a respective bobbin.

It is beneficial that the marker is defined by a agglomerate of pixels and that the size and form of the agglomerate of pixels corresponds to the area of the fault.

The different types of faults may be assigned to different colours which are used for the marker. For example, the colour of the pixels showing an elastane-free fault may be red, the colour of the pixels showing a damaged bobbin fault may be green, the colour of the pixels showing an abrasion fault may be blue, the colour of the pixels showing a diameter fault may be yellow. The respective marker may be overlaid on the respective image of the respective yarn bobbin, which is acquired with the image acquisition device, and this overlaid image can be visualized on a display. The respective human person operating the system can then view on the display where the respective fault is assigned. To further facilitate the determination of where the fault is located for the operator, it is beneficial that, when on the display, the image of the yarn bobbin (without the overlaid marker) is depicted next to the image of the yarn bobbin (with the overlaid marker) and both images being of the same size (magnification). Than in the image not having the marker, the location of the fault is better visible.

Although the respective transport of yarn bobbins through the system is not delimited, it was seen as beneficial that the respective system comprises a bobbin holder which is mounted on a rail. The bobbin holder can be moved along the rail through an inspection zone (which is the zone in which the image acquisition is executed).

From a batch of bobbins to be inspected, the respective yarn bobbins may be put by hand by the user (operator), or automatically by a robot to the respective bobbin holder. Via the bobbin holder, the yarn bobbin is moved through the inspection zone. Thereafter, the yarn bobbin can be taken from the yarn holder manually by a human person or automatically by a robot, and can be automatically assigned to a pallet at which the bobbins having the respective faults are stored and/or to a pallet wherein bobbins having no fault are stored.

The assignment may be done automatically or by a respective light system having a red or green light. The green light corresponds to a yarn bobbin having no fault, and therefore the yarn bobbin can be assigned by the operator to a package of yarn bobbins which should be sent to a customer. The red light corresponds to a yarn having a fault. Also different light types can be used for assigning yarn bobbins to different fault types.

According to a further development, the yarn bobbin holder is adapted to rotate the yarn bobbin along an axis, which is perpendicular to a bobbin central axis and may also be perpendicular to the rail extension direction. It is an advantage that the respective yarn bobbin is moved along its longitudinal direction along the rail. However, in the inspection zone, it is beneficial to rotate the respective yarn bobbins by 90° such that the respective axis direction of the bobbin is perpendicular to the direction along which the rail extends.

With such a configuration, the respective end surfaces in the longitudinal direction of the bobbin can be better inspected as usually the respective image acquisition device is mounted on different sides sandwiching the rail extending there between in a longitudinal direction. The rotation of the yarn bobbin may also be executed during the image acquisition in order to make the image acquisition at different areas of the yarn bobbin.

The respective bobbin holder may be constructed as a ring having a fixing area in which the yarn bobbin can be placed. The yarn bobbin should be placed such that the relative movement of the yarn bobbin is prevented. This may be a movement in the circumferential direction or this may be a movement in the translation direction of the yarn bobbin. It is beneficial that the relative movement in both the circumferential direction and the translation direction is prevented.

The fixing area may be defined by two parallel extending rods which extend in a direction of a ring central axis of the ring defining the bobbin holder. The two parallel extending rods can have a gap there between holding the bobbin at its outer circumferential surface. With such a configuration, it is easy to place yarn bobbins having a different diameter into the same holder.

The respective ring of the bobbin holder may have a rotation hinge mounted via a moveable element to the rail. In the particular inspection system it is beneficial that a plurality of such bobbins holders are arranged one after each other along the rail, and it may be an advantage that the bobbin holders are adapted to be moved together along the rail. That means that each of the respective bobbin holders may be connected to a neighbour bobbin holder by a chain or cable or other coupling, such that when the chain or cable or other coupling is drawn along the respective rail, the bobbin holders are moved through the system at a defined distance from one-another.

It is further beneficial that the system comprises a dark-chamber having two openings through which the rail extends from an entry and an exit. The image acquisition device or image acquisition devices may be provided within the dark chamber. When such a dark chamber is used, the surrounding light is prevented from disturbing the image acquisition and from generating artefacts.

However, it is not necessary to use such a dark chamber, in particular it is not necessary when the image acquisition device does not work in the visible spectrum but when it works in an infra-red or X-ray spectrum.

It is beneficial that the respective image acquisition device comprises an illumination section illuminating an area of the yarn bobbin for fault inspection and a camera device for acquiring an image of the area. Via the illumination section, the respective area can be illuminated and via the camera, the illuminated area can be photographed.

Further, the system may comprise an image processing and adjustment module.

Via the image processing and adjustment module, the respective acquired image can undergo a filtering. The respective filtering may be able to provide a better data quality, in which it is easier to detect the respective type of fault.

It has been shown as beneficial that for each different type of fault, a different image acquisition device is used. This is the case because for the different types of faults different image acquisition conditions can be preferred. On the one hand, for the different types of faults a different filtering can be applied with the image processing and adjustment module. On the other hand, and/or additionally the respective camera device used is sensitive for different wavelengths and/or the respective illumination section irradiates radiation having a different wavelength and/or having a different wavelength region and/or colour temperature.

In particular, the illumination section is operated at a specific wavelength or colour temperature depending on the fault type to be detected.

Depending on the fault type to be detected, there may also be used a different filter in the image processing and adjustment module.

The respective image acquisition device used may be one or more of the following. An image acquisition device for elastane-free fault, an image acquisition device for damaged bobbin fault, an image acquisition device for abrasion fault, an image acquisition device for color fault, and an image acquisition device for diameter fault.

The respective fault types have already been explained in the foregoing section. The respective difference in the image acquisition device may be that they are operated at a different wavelength and/or different colour temperature and/or that the respective camera device may have a different sensitivity.

In particular, for the image acquisition device for the elastane-free fault, it was seen as beneficial that the illumination section having a ring form, and that the camera device is provided in a center region of the ring. This ring form illumination section is mounted such that it irradiates the respective beam to a respective end surface in the longitudinal direction of the yarn bobbins. Therefore the respective center axis of the ring of the illumination section may be provided perpendicular with respect to the extension direction of the rail.

In particular, it was seen as beneficial that two image acquisition devices for elastane-free fault detection are provided sandwiching the rail. It is an advantage that the both image acquisition devices are centrally aligned with respect to each other and that said aligned center is orthogonal to the extension direction of the rail.

Further thereto it was seen as beneficial that upstream and downstream of the image acquisition device for elastane-free fault at least one further image acquisition device is provided. Such an image acquisition device may be an image acquisition device for abrasion fault, colour fault, diameter fault or the like.

The system may be further configured that yarn bobbins which are fed to the system are automatically sorted depending on the fault type which is detected.

The system may be further configured that periodically the data acquired during the fault detection is stored in the database after it is confirmed by a human person (operator) that the actually detected fault corresponds to a type of fault which is assigned to the yarn bobbin from the system.

In view of this, it is beneficial to have the display unit and the marker on the overlaid image. Therefore a respective human person who operates the inspection system can instantaneously feed the database and to input a database with more data (a broader dataset) for having a better assignment to the type of faults.

Generally the system is configured that the fault assignment to different types of fault is done by Artificial Intelligence and (or) in particular the system works with Deep Learning.

Further to the aforementioned inspection system, it is provided a method for inspecting yarn bobbins and assigning different types of fault thereto. The method uses for fault assignment an application and a database. The respective aforementioned aspects described with respect to the system may also be provided for the respective inspection method.

The method may be an automatic method which is executed on a computer.

Further, it may be provided a computer readable application which makes the respective bobbin inspection and/or controls the respective system automatically.

In the following, there are described some embodiments of the invention with respect to the figures.

Herein,

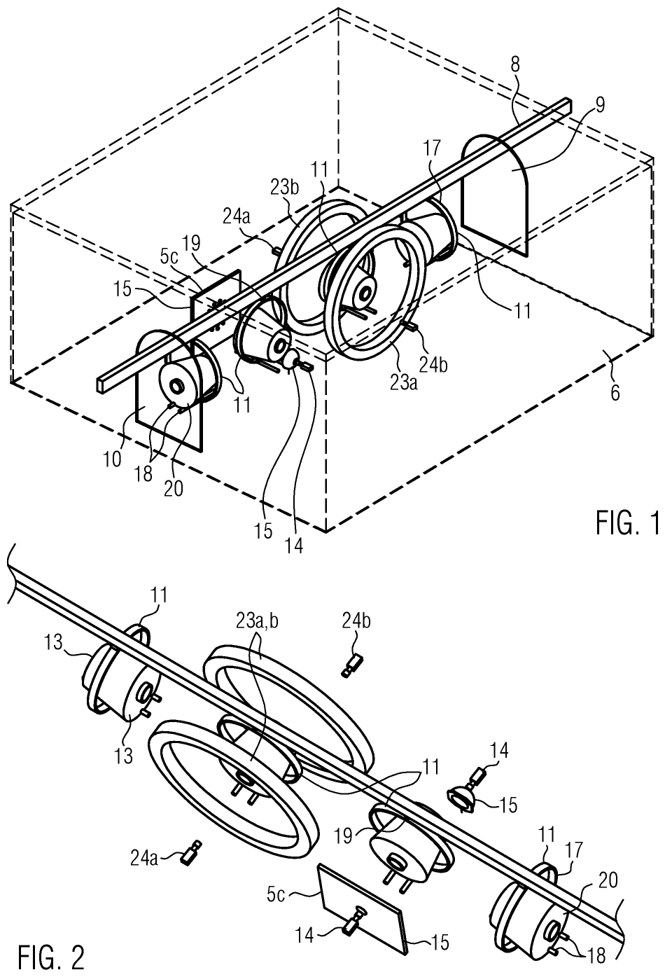

FIG. 1 shows a schematic view of a part of the system comprising the inspection zone, which is provided in a dark chamber.

FIG. 2 shows an arrangement of the inspection zone within the dark chamber in details.

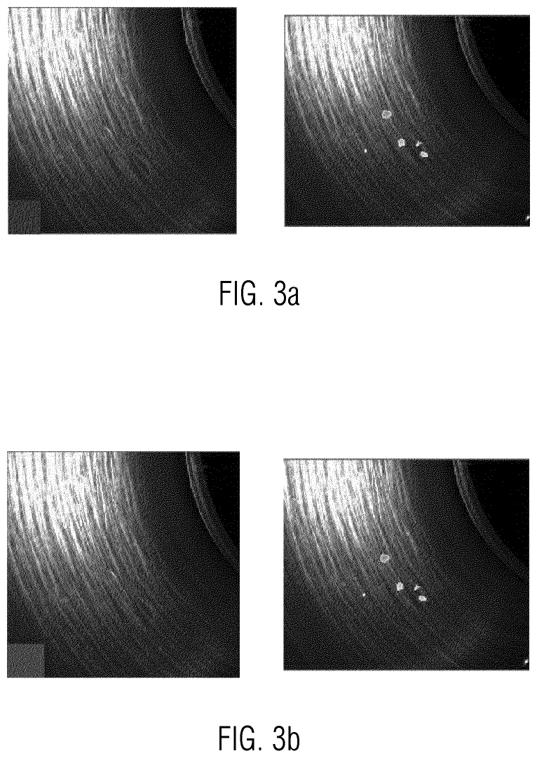

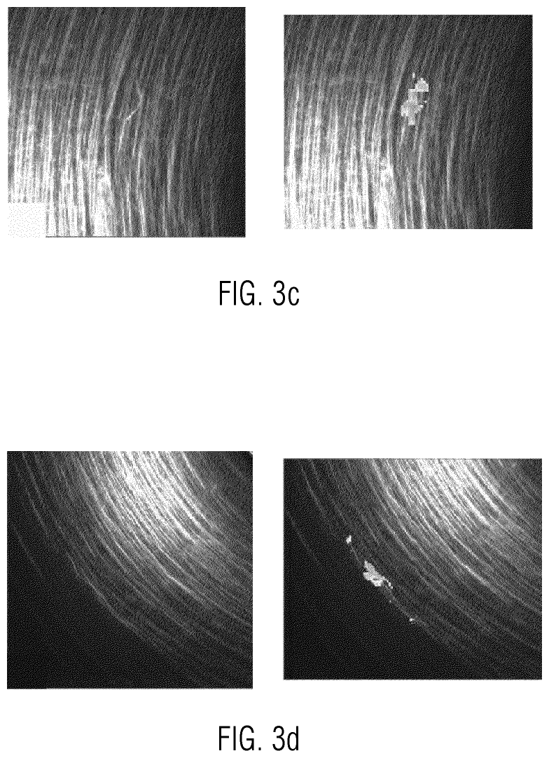

FIGS. 3a, 3b, 3c and 3d show different images in which an elastane-free fault is detected and a respective image overlaid with a marker is produced (respective right hand side of FIGS. 3a, b, c, d).

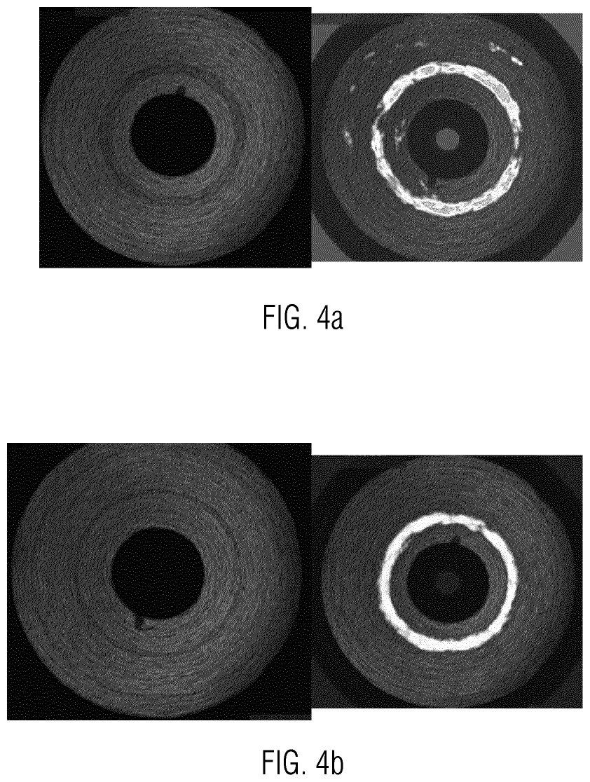

FIGS. 4a and 4b shows an image generated by an abrasive fault detection. In the right side of the figures, the abrasive fault area is assigned by a marker to an area on the end sides in the longitudinal direction of the respective yarn bobbins.

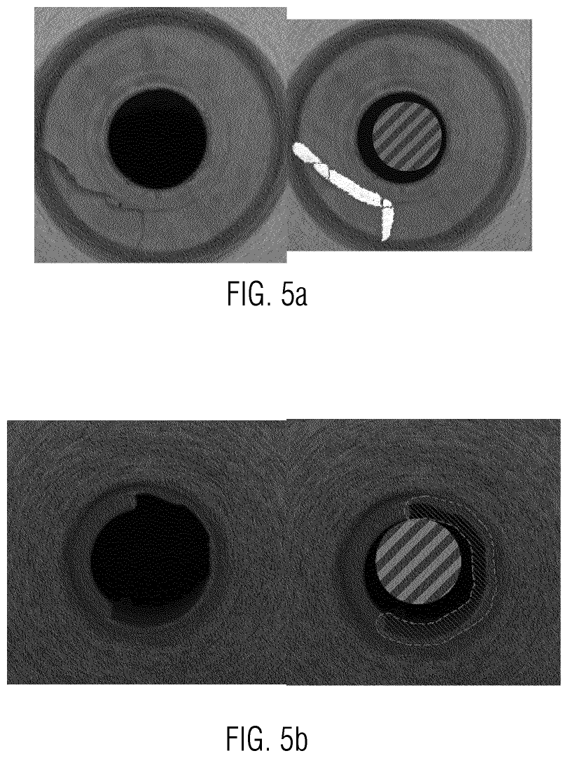

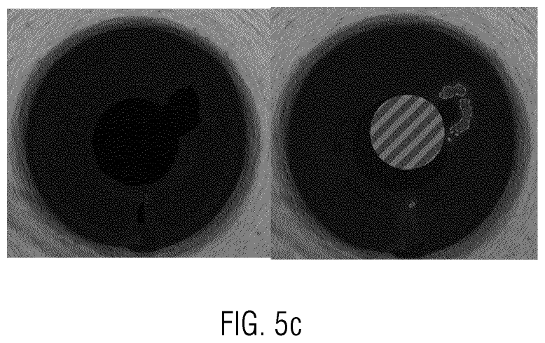

FIGS. 5a, 5b and 5c show a damaged bobbin fault and a respective marker overlaid to the acquired image on the respective right hand side of FIGS. 5a-c.

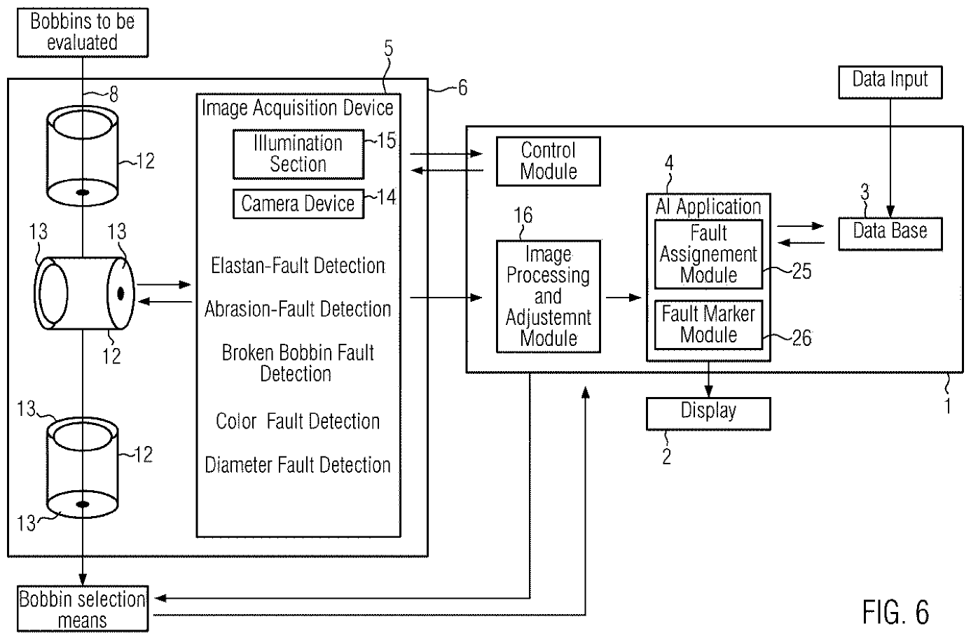

FIG. 6 shows a schematic configuration of the complete system.

On the right hand side in FIG. 6 there is shown a computer 1 and a display 2. The computer 1 may have a database 3 stored in a storage area and an application 4 running on this computer. An image acquisition device 5 is connected to the computer 1 and data can be exchanged between the image acquisition device 5 and the computer 1. Via an interface, data can be input to the respective database 3. This is schematically shown by the box “Data Input” in FIG. 6. The image acquisition device 5, and/or a bobbin selection means for selecting the respective yarn bobbins after fault determination, and/or the transport of the yarn bobbins 12 along a later described rail 8 can be controlled by a control module in the computer 1. Said control module may also be integrated in the application 4. However, in FIG. 6 the control module is depicted as a separate independent module in the computer 1.

On the left hand side of FIG. 6 there is shown a schematic configuration of a dark chamber 6, in which the image acquisition device 5 is mounted in the specific case. The rail 8 extends from an entrance opening 9 of the dark chamber 6 to an exit opening 10 of the dark chamber 6 (e.g. also FIG. 1).

Yarn bobbins 12 to be evaluated are first placed on a holder 11, which is not shown in said figure (however it is identified with reference sign 11 in FIGS. 1 and 2). The holder 11 is mounted on the rail 8. The yarn bobbin 12 mounted on the holder 11 is then moved along the rail 8 into an inspection area within the dark chamber 6. At the inspection area, the image acquisition device 5 acquires an image of the respective bobbin. In the particular case, it may be beneficial that the image is taken from the respective end surfaces, delimiting the yarn bobbin in the longitudinal direction thereof. The end surfaces have reference sign 13 in FIG. 6. However, the inspection is not delimited to the respective end surface, and can also be done at the respective outer circumferential surface. Also the inspection within the interior of the yarn bobbin 12 can be done when the respective image acquisition device works with a wavelength or a wavelength region penetrating the yarn bobbins.

However, in the specific case, the respective image acquisition device comprises a camera device 14 and an illumination section 15. Via the illumination section 15 irradiation having a specific wavelength or comprising waves of a specific wavelength band, or having a specific colour temperature is illuminated to the respective yarn bobbin 12.

With a respective camera device 14, an image of the illuminated yarn bobbin 12 is taken. The respective image data is transferred to the computer 1. In a respective image processing and adjustment module 16, which may be a part of the computer 1, a respective filtering rule may be applied depending on the respective fault to be detected. The respective filtered data are fed to the application 4. In the application 4 it is decided which of a respective plurality one of fault types is provided at the yarn bobbin 12 under evaluation. After the respective bobbin inspection, the yarn bobbins 12 are moved through the exit opening 10 out of the dark chamber 6 and the yarn bobbins 12 may be selected and the respective yarn bobbins 12 having no fault or no significant fault can be assigned to a respective batch of yarn bobbins to be shipped to a customer.

The respective image acquisition device 5 may have an abrasion detection function, a broken bobbin detection function, a colour detection function, a diameter detection function and an elastane-free zone detection function. With the respective function, the respective fault may be detected.

In the specific case shown in FIG. 6 the respective functions are shown as alternatives or may be simultaneously present for the one image acquisition device 5 shown therein. The respective functions may be provided within one image acquisition device however there may be provided separate image acquisition devices which each comprise a camera device 14 and a respective illumination section 15. In each of the respective image acquisition devices, the respective camera device and illumination section may have a different specific configuration in relation to the irradiated wavelength or wavelength regions or sensitivity. This will be explained in the following section later.

However, by the image acquisition device 5, image data is generated which is fed to the application 4.

In the application 4 the respective data is compared with a dataset stored in the database 3. This database 3 is set up by feeding data of respective types of faults to the database 3. In order to do so, in a first step to initiate the respective inspection system, yarn bobbins 12 having a respective type of fault are inspected with the system and the respective data is assigned to a specific fault type. In order to do so, the data may have an identifier identifying a specific fault. This feeding in of yarn bobbins having different types of fault may be done for different faults. For example 10 to 100 yarn bobbins having an elastane-free fault are fed into the system and the respective data derived with the image acquisition device is fed to the database.

Further 10 to 100 yarn bobbins having a broken bobbin fault are used for generating bobbin fault data in the database. The same can be done with sample bobbins having abrasion faults, bobbins having different specific diameters, and bobbins having specific colours.

This training of the database and the adding of further data to the database may be done periodically after specified periods or numbers of inspected yarn bobbins or simultaneously during the inspection of the respective yarn bobbins to be evaluated. In order to do so, it is necessary to match the respective identified fault (which is identified by the system) and see whether it corresponds to the respective fault which should be identified.

This can be done by a human person.

This can either be done after the respective yarn bobbins come out of the exit opening 10 and a respective human person (operator) looks at the fault and decides if the fault correspond to the identified fault, which was identified by the system. In this case, the respective data is fed to the database as data corresponding to this type of fault.

This assignment may also be done with the help of the display device where a human person looks at the display device. In order to help the operator to assign whether the respective detected fault corresponds to the respective fault which is actually present in the respective yarn bobbin, there may be provided a colour marking or at least a marking which is superimposed onto the acquired image.

The acquired image may be any image, it may be an X-ray image, which can not only inspect the surface of the yarn bobbin, but also the interior of the yarn bobbin. However the respective marker may be generated by a plurality of pixels which corresponds to the area at which the fault is detected.

Therefore by comparing an image without the pixels and an image having the pixels when the images are placed adjacent to each other on a screen, the operator can confirm whether the detected fault corresponds to the fault type which is assumed to be detected and in this case the respective data can be assigned to the database and becomes an identifier characteristic for said type of fault.

By this configuration, the respective database 3 and application 4 can be trained.

The application 4 is an application using artificial knowledge and searches for similarities between the acquired images and the images having a specific fault in the database. In order to have a good database, it is beneficial to have for the specific faults, for example an elastane-free etc. . . . fault, sample yarn bobbins in which an aspect of fault location, fault extension or fault size is very different. Thus the differences between the aspects of the specific type of faults have a strong variation. Therefore it is much easier to have a more reliable assignment of the acquired image of a bobbin to be evaluated. The broader the variety of the aspects of the specific faults (the variety of an elastane-free fault for example) the more reliable the data generated and the suitability to be used with the application.

FIG. 1 shows an example of the configuration of the left side of the system shown in FIG. 6. FIG. 1 shows the dark chamber 6 which surrounds the inspection area. The respective rail 8 extends from the entrance opening 9 to the exit opening 10. The respective opening may have a respective opening area which is from to 22 that is 150% bigger than the respective yarn bobbin cross-sectional area perpendicular to its longitudinal axis. This reduced size opening prevents too much light getting into the inspection area.

The rail 8 can also be seen in FIG. 2. Hanging therefrom are rings 17 which correspond to the bobbin holder 11. At a lower side of the ring 17 opposite to the side where the rotational hinge 19 is provided, there are provided two parallel extending rods 18 which have provided a gap 20 there between. Within the gap 20 the respective outer circumferential surface of a respective yarn bobbin 12 can be fixed. Thus it is possible to prevent a translational movement of the bobbin. However the yarn bobbin itself may be still rotated with respect to its central axis.

The respective ring 17 is mounted via the rotational hinge 19 to a moveable element provided at the lower side of the rail 8, which moveable element is not visible in the figures, and the respective ring can be rotated as it is shown in the sequence of FIGS. 1 and 2.

Namely, when the respective yarn bobbin 12 enters the dark chamber 6, the bobbin direction (the axial direction) corresponds to the longitudinal direction of the rail. In the inspection area the bobbin is (automatically, e.g. by the control module) rotated, in the specific case by approximately 90° such that it is possible to inspect the front and rear end surfaces of the respective yarn bobbin 12. However, it may also be executed a rotation of the yarn bobbin during the image acquisition in the inspection area.

In the specific configuration shown in FIGS. 1 and 2, the elements having reference sign 23a, 23b correspond to the illumination section of an image acquisition device for identifying an elastane-fault of the yarn bobbin. The elements having reference sign 24a, 24b correspond to a camera device of said respective image acquisition device for determining an elastane-fault. The respective camera device 24a, 24b is provided in a central area along a central axis of the illumination section 23a, 23b. The illumination section is defined by a ring which illuminates at a specific wavelength or wavelength band or light temperature the respective region of the yarn bobbin.

The respective illumination wavelengths and/or the respective sensitivity and the camera device is chosen in view of good abilities to detect the elastane-free fault. In this particular case, for the elastane-free fault, two image processing and image acquisition devices are provided on opposite sides of the respective yarn bobbin 12 and sandwiching the rail 8.

In the specific case of the present example downstream of this image acquisition device for elastane-free fault detection, there are provided an image acquisition device for abrage detection and an image acquisition device for colour fault detection. The image acquisition device for colour fault detection has reference sign 5b. The image acquisition device for abrage fault detection has reference sign 5c. Each device comprises a respective illumination section and a camera section. In particular, the respective illumination for abrage detection has a plate-like shape and the camera is provided viewing through the hole in the plate-like shape onto an end surface of the respective yarn bobbin, such that a plane wave irradiation is provided.

The illumination section for colour fault detection has a bell-like shape such that the irradiation beams are irradiating the sample at different angles. Also in the case of the image acquisition device for the colour fault detection, concentrically the respective camera device 14 is held.

After respective measurements are executed and the respective holders 11 are moved through the inspection zone, the respective holder 11 is rotated back to the original direction and then the respective holder 11 is moved through the exit opening 10 out of the system.

At this point the yarn bobbin is removed from the holder and the bobbin selection is executed, for example in an automatic way as indicated by the arrows between the computer and the box “Bobbin selection means” in FIG. 6. This automatic selection can also be controlled by the control module.

In the respective FIGS. 3, 4 and 5 there is shown how in the application 4 the respective data may be processed such that a respective marker is generated. In order to do so the application 4 has, additionally to the fault assignment module 25, a fault marker module 26.

In the fault assignment module 25, the respective fault assignment is done via the respective matching of the acquired image data with data in the database 3 via Artificial Intelligence. Via the respective fault marker module 26, there is generated a marker which may be in the present case a group of specific pixels corresponding to the area where the respective fault is detected.

This marker is overlaid to the image and on the display 2 there may be shown (as shown in FIGS. 3a, 3b, 3c and 3d) respective images without the marker and the corresponding region of the image with the marker (the left images in FIGS. 3 to 5 are images without the marker and the respective right images are images with the superimposed marker at the same location and with the same magnification as the image without the marker). Therefore, when a user looks at the display 2 he may see at which location in the respective region in the original figures a respective fault is detected and what the fault looks like.

The respective fault shown in FIG. 3a to d correspond to elastane-free faults. Elastane-free faults have a specific characteristic which is, for example, best seen in FIG. 3c. On the left hand side of FIG. 3c there can be seen in the area in which at the right hand image the respective marker is shown, that the respective yarn is not extended in the circumferential section, but has a wave. From this wave form, it can be derived that there is no elastane provided in the core at said section of the yarn because there the yarn is hanging loose which makes the wave form appearance.

It has been for the first time shown by the present inventors that the specific elastane-free faults can be determined by Artificial Intelligence and that a respective marker can be assigned thereto.

For example, by comparing FIGS. 3a to d with FIGS. 4a and b, which show the resulting images (with and without marker, left and right image in FIG. 4) obtained by the image acquisition device for abrasion detection, that the image acquisition device for acquiring the elastane-free fault may have a higher resolution than the image acquisition device for an abrasion fault.

However, the abrasive detection is done in the same way and in FIGS. 4a, 4b there are shown in the left side the respective figures without having the marker overlaid to the image, and on the right side a marker overlaid to the image. The marker in this case is red, while the marker showing the elastane free fault is yellow.

Therefore, although in the present case on the respective screen each fault image is shown separately. These images may also be superimposed and the fault may be marked with different colours.

FIGS. 5a, 5b, and 5c show different faults of the bobbin itself. Also in the case of said figures, the respective image depicted on the left side has the marker superimposed and the image on the right hand side has no marker. In the case of FIG. 5a, the bobbin is broken and a broken line is shown as a marker. In FIG. 5b a part of the bobbin is missing.

In FIG. 5c there is no bobbin provided.

As the left hand side shows the acquired image and the right hand side shows the image superimposed with the respective markers and as both images are shown adjacent to each other on the display 2, when both images are of the same size, visualized adjacent to each other, the respective user may identify whether the respective faults corresponds to the assumed fault which is automatically identified with the system. When this is the case, he assigns the respective data to be input into the database and the data can be used to improve the database and thus the subsequent fault determination.

The present invention is not delimited to the aforementioned specific configuration, but in the broadest sense can generally be applied for determining a fault in an yarn bobbin by matching acquired data with data in a database which is beforehand stored for the respective type of fault.

In particular, the present invention is related to a system and method using Artificial Intelligence and using Deep Learning, which is trained during the process with further data.

In the particular configuration the respective faults can automatically be detected and the sorting of the yarn bobbins to different batches can be done.

Further to the specific system, there may be also provided a respective inspection method and/or an application with which the respective method can be executed on a computer.

Although it is described in the specific embodiment that the respective application and database is provided at one computer. It may also be the case that the database is provided remote from the application and the application is an application executable on a PDA or another remote terminal device wherein the application is an application executable over the internet. The respective control of the application may also be done remote from the respective facility where the respective inspection of the yarn bobbins is conducted. The respective inaction of the different elements may be done by wireless communication or alternatively via a local area network.

### REFERENCE SIGN LIST

1 Computer
2 Display
3 Database
4 Application
5 Image Acquisition Device
5b Image Acquisition Device for colour fault detection
5c Image Acquisition Device for abrage detection
6 Dark Chamber
8 Rail
9 Entrance Opening
10 Exit Opening
11 Holder
12 Yarn Bobbin
13 End Surfaces
14 Camera Device
15 Illumination Section
16 Image Processing and Adjustment Module
17 Ring
18 Rod
19 Rotation Hinge
20 Gap
23a, 23b Illumination Section of an Image Acquisition Device for identifying an elastane-fault of the Yarn Bobbin
24a, 24b Camera Device of an Image Acquisition Device for identifying an elastane-fault of the Yarn Bobbin
25 Fault Assignment Module
26 Fault Maker Module

1. An inspection system for yarn bobbins, comprising
an image acquisition device for acquiring an image of a yarn bobbin,
a database in which there is stored a first data set concerning at least a first type of fault, which first data set is generated by using samples of yarn bobbins having the first type of fault,
an application for determining whether the yarn bobbin, which is inspected with the image acquisition device has the first type of fault.

2. The inspection system according to claim 1, wherein the inspection system is configured that in the database there is stored a second data set concerning at least a second type of fault, which second data set is generated by using samples of yarn bobbins having the second type of fault.

3. The inspection system according to claim 2, wherein the application is configured to determine whether the yarn bobbin which is inspected with the image acquisition device has the first type of fault and/or the second type of fault.

4. The inspection system according to claim 1, wherein the type of fault is chosen from the group comprising the following: elastane-free fault, damaged bobbin fault, abrasion fault, color fault, diameter fault.

5.-6. (canceled)

7. The inspection system according to claim 1, wherein the application has a fault assignment module assigning the type of fault of the yarn bobbin which is inspected with the image acquisition device to said yarn bobbin, and
an fault marker module, which generates data for providing a marker, which can be overlaid to the image of the yarn bobbin which is acquired by the image acquisition device.

8. The inspection system according to claim 7, wherein the marker is defied by an agglomerate of pixels, wherein size and form of the agglomerate of pixels correspond to an area of the fault.

9. The inspection system according to claim 7, wherein the inspection system is configured that for different type of faults different colors are used for the marker.

10. (canceled).

11. The inspection system according to claim 1, wherein the inspection system further comprises a bobbin holder which is mounted on a rail, along which the bobbin holder can be moved through an inspection zone, which is a zone in which the image acquisition device is executed.

12. (canceled)

13. The inspection system according to claim 11, wherein the bobbin holder is constituted by a ring having a fixing area in which the yarn bobbin can be placed in order to prevent a relative movement of the yarn bobbin within the bobbin holder in at least one of a circumferential direction and/or a translation direction.

14.-15. (canceled)

16. The inspection system according to claim 11, wherein a plurality of bobbin holders are arranged one after each other along the rail.

17. The inspection system according to claim 16, wherein the plurality of bobbin holders are adapted to be moved together along the rail.

18. The inspection system according to claim 11, wherein the inspection system further comprises a dark-chamber, having two openings through which the rail extend from an entry to an exit.

19. The inspection system according to claim 18, wherein the image acquisition device is provided within the dark-chamber.

20. The inspection system according to claim 1, wherein the image acquisition device comprises a illumination section illuminating an area of the yarn bobbin for fault detection, and an camera device, for acquiring the image of the area.

21. The inspection system according to claim 1, wherein the inspection system further comprises an image processing and adjustment module.

22. The inspection system according to claim 1, wherein the inspection system is configured that for determination of the fault, depending on a fault type to be detected, a different image acquisition device is used.

23.-24. (canceled).

25. The inspection system according to claim 18, wherein at least one of the following image acquisition device types is provided within the dark-chamber: an image acquisition device for elastane-free fault, an image acquisition device for damaged bobbin fault, an image acquisition device for abrasion fault, an image acquisition device for color fault, and an image acquisition device for diameter fault, wherein an elastane-free fault is a fault wherein there is an area along the yarn in which there is a region where there is no elastane provided in an elastane containing yarn.

26. The inspection system according to claim 25, wherein the image acquisition device type is an image acquisition device for elastane-free fault, wherein the image acquisition device for elastane-free fault has an illumination section having a ring form and a camera device provided in a central region of the ring.

27.-31. (canceled)

32. A method for inspecting yarn bobbins and assign different type of faults thereto, wherein the method uses for fault assignment an application and a database, wherein the method is carried out with the inspection system according to claim 1.

33. The inspection system according to claim 26, wherein the illumination section is mounted such that it irradiates the respective beam to a respective end surface in a longitudinal direction of the yarn bobbins.
